(19) United States
(12) Patent Application Publication
(10) Pub. No.: US 2025/0392179 A1
(43) Pub. Date: Dec. 25, 2025

(54) EFFECTIVE COOLING SYSTEM FOR HIGH TORQUE ELECTRIC MOTORS USING MICROCHANNELS AND TWO-PHASE COOLANTS

(71) Applicant: Board of Regents, The University of Texas System, Austin, TX (US)

(72) Inventors: Babak Fahimi, Plano, TX (US); Milad Bahrami Fard, Richardson, TX (US)

(21) Appl. No.: 19/242,057

(22) Filed: Jun. 18, 2025

Related U.S. Application Data
(60) Provisional application No. 63/661,878, filed on Jun. 19, 2024.

(51) Int. Cl. H02K 3/24; H02K 1/16; H02K 3/12; H02K 3/30; H02K 3/34; H02K 15/062; H02K 15/40

(52) U.S. Cl. CPC H02K 3/24; H02K 1/16; H02K 3/12; H02K 3/30; H02K 3/345; H02K 15/062; H02K 15/40; H02K 2213/12

(57) ABSTRACT

An electric machine including a direct thermal contact end-winding microchannel heat exchanger is provided. A plurality of insulators are coupled to a stator. A plurality of windings are coupled to the plurality of insulators. A direct thermal contact end-winding microchannel heat exchanger is coupled to a section of the plurality of insulators that extends beyond the stator. The direct thermal contact end-winding microchannel heat exchanger is in direct thermal conduction with a section of the plurality of windings that extends beyond the first end to remove heat from the plurality of windings. According to other illustrative embodiments, a method and modular machine are provided.

### CROSS REFERENCE TO RELATED APPLICATION

Referring to the application data sheet filed herewith, this application claims a benefit of priority under 35 U.S.C. 119(e) from co-pending provisional patent application U.S. Ser. No. 63/661,878, filed Jun. 19, 2024, the entire contents of which are hereby expressly incorporated herein by reference for all purposes.

### FIELD

The field of the invention includes cooling systems for electric motors, more specifically effective cooling systems for high torque electric motors using direct end-winding microchannels and optionally two-phase coolants.

### BACKGROUND

Use of electric machines with high torque and power density are becoming more prevalent as transportation industry transitions to electrified platforms. Design of electric machines encompasses a multi-physics process including electromagnetic design, structural analysis, and thermal management. Electric motor designers traditionally prioritize electromagnetic optimization for industrial, stationary applications due to lower power density requirements. However, the use of electric motors in electric vehicles (EVs) has highlighted the need for a more rigorous thermal management system. As a result, thermal constraints have rapidly become the primary limiting factor in achieving higher power density and reliability goals for electric motors. Elevated temperatures can lead to degradation of the winding insulation, and typically, a 10° C. increase in the motor's average operating temperature, beyond its temperature limits, reduces the insulation's lifespan in half.

Traditional cooling systems, such as housing fins that rely on natural convection, often prove to be inadequate for cooling high-power density machines. Employing forced air convection with shaft-mounted or external fans can enhance thermal performance of the motor. However, this kind of cooling system frequently falls short of the motor power density requirements that is required for EVs. As a result, liquid cooling techniques involving ducts, channels, or water jackets have gained traction over the past decades. The water jacket system is a common example, in which heat from the windings is dispersed by a coolant flowing via channels around the stator. Although the active winding region is successfully cooled by these techniques, the end-windings are not as effectively cooled, which causes localized hot spots in this part of the machine. Moreover, the high thermal resistance in the path from the winding to the coolant hinders the cooling efficiency of the water jacket.

The majority of ongoing research on cooling are focused on direct cooling techniques, which significantly reduce thermal resistance between the coolant and windings by putting the heat exchanger in direct contact with windings, especially the end-windings. Various direct cooling solutions have been developed for the slot-winding regions, such as thin ducts with internal pin fins that channel coolant through the heat exchanger to extract heat from the windings. While these solutions demonstrate excellent power density results, their mass production, maintenance, and recycling pose significant challenges. Additionally, these cooling solutions do not extend to the end-windings, which experience the highest temperatures, necessitating a separate direct cooling method for this area. End-winding cooling methods, such as spray cooling, offer effective heat dissipation directly on the winding surface. However, these methods are prone to reliability issues like nozzle corrosion and erosion, posing single point of failure risks. Alternatively, using a highly conductive potting material to cover end-windings provides significant temperature reduction, but it can be expensive, vulnerable to motor vibrations that causes cracks, and typically requires a vacuum process for optimal cooling.

### SUMMARY

To address the above discussed shortcomings, an effective cooling system for stator windings of adjustable speed AC drives is proposed. The proposed design allows for effective usage of slot area for placement of the conductors at a very high filling factor with high current density. The embedded cooling and end windings are separately designed and comprise of intertwined microchannels (carrying two-phase coolant) and conductors. This will allow for an optimal usage of space, modular design, ease in repair and more importantly, effective removal of the heat by providing direct contact with the source of heat.

There is a need for the following embodiments of the present disclosure. Of course, the present disclosure is not limited to these embodiments.

According to an embodiment of the present disclosure, an electric machine comprises: a stator having a first end and a second end and defining a plurality of slots; a plurality of insulators coupled to the stator, located at least partially in the plurality of slots, and extending beyond the first end; a plurality of windings coupled to the plurality of insulators, located at least partially within and surrounded by the plurality of insulators, and extending beyond the first end; and a direct thermal contact end-winding microchannel heat exchanger coupled to a section of the plurality of insulators that extends beyond the first end, wherein the direct thermal contact end-winding microchannel heat exchanger is in direct thermal conduction with a section of the plurality of windings that extends beyond the first end to remove heat from the plurality of windings.

According to another embodiment of the present disclosure, a method of making an electric machine comprises: providing a stator having a first end and a second end and defining a plurality of slots; coupling a plurality of insulator sleeves to the stator, wherein the plurality of insulator sleeves are located at least partially in the plurality of slots, and extend beyond both the first end and the second end; coupling a first modular direct thermal contact end-winding microchannel heat exchanger coupled to a section of the plurality of insulator sleeves that extends beyond the first end; coupling a second modular direct thermal contact end-winding microchannel heat exchanger coupled to a section of the plurality of insulator sleeves that extends beyond the second end; and inserting a plurality of windings through the plurality of insulator sleeves wherein the plurality of windings insulator sleeves extend beyond both the first end and the second end and extend beyond both the first modular direct thermal contact end-winding microchannel heat exchanger and the second modular direct thermal contact end-winding microchannel heat exchanger.

According to another embodiment of the present disclosure, an electric machine comprises: a stator having a first end and a second end and defining a plurality of slots; a plurality of insulators coupled to the stator, located at least partially in the plurality of slots, and extending beyond both the first end and the second end; a plurality of windings coupled to the plurality of insulators, located at least partially within and surrounded by the plurality of insulators, and extending beyond both the first end and the second end; a first modular direct thermal contact end-winding microchannel heat exchanger coupled to a section of the plurality of insulators that extends beyond the first end; and a second modular direct thermal contact end-winding microchannel heat exchanger coupled to a section of the plurality of insulators that extends beyond the second end, wherein both the first modular direct thermal contact end-winding microchannel heat exchanger and the second modular direct thermal contact end-winding microchannel heat exchanger are in direct thermal conduction with the plurality of windings to remove heat from the plurality of windings, and wherein both the first modular direct thermal contact end-winding microchannel heat exchanger and the second modular direct thermal contact end-winding microchannel heat exchanger define a substantially equal shape and size.

These, and other, embodiments of the present disclosure will be better appreciated and understood when considered in conjunction with the following description and the accompanying drawings. It should be understood, however, that the following description, while indicating various embodiments of the present disclosure and numerous specific details thereof, is given for the purpose of illustration and does not imply limitation. Many substitutions, modifications, additions and/or rearrangements may be made within the scope of embodiments of the present disclosure, and embodiments of the present disclosure include all such substitutions, modifications, additions and/or rearrangements.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1A is a schematic illustration of a 3D model of a microchannel cooled electric machine (electric motor) in accordance with an embodiment of the present invention.

FIG. 1B is an exploded view of a microchannel cooled electric machine in accordance with an embodiment of the present invention.

FIG. 2A is a schematic illustration of a section of an electric machine in accordance with an embodiment of the present invention.

FIG. 2B is a schematic illustration of a direct end-winding microchannel heat exchanger in accordance with an embodiment of the present invention.

FIG. 3A is a schematic illustration of mesh for an FEA model in accordance with an embodiment of the present invention.

FIG. 3B is an enlarged schematic illustration of a portion of the mesh for the FEA model in accordance with an embodiment of the present invention.

FIG. 4 is an illustration of temperature distribution of a motor with 12 A/mm² current density using microchannel cooling in accordance with an embodiment of the present invention.

FIG. 5 is an illustration of temperature distribution of the motor with 24 A/mm² current density using microchannel cooling in accordance with an embodiment of the present invention.

FIG. 6 is an illustration of temperature distribution of a motor with 12 A/mm² current density using water-jacket cooling in accordance with an embodiment of the present invention.

FIG. 7 is an illustration of temperature distribution of the motor with 24 A/mm² current density using water-jacket cooling in accordance with an embodiment of the present invention.

FIG. 8 is a schematic illustration of a microchannel cooling system comprising an electric motor configured with a microchannel heat exchanger connected within an active cooling system in accordance with an embodiment of the present invention.

FIG. 9A is an illustration of a section of a motor with direct thermal contact end-winding microchannel heat exchanger in accordance with an embodiment of the present invention.

FIG. 9B is an illustration of a detailed close-up of a portion of the section of the motor with direct thermal contact end-winding microchannel heat exchanger in accordance with an embodiment of the present invention.

FIG. 9C is an illustration of the direct thermal contact end-winding microchannel heat exchanger in accordance with an embodiment of the present invention.

FIG. 10A is an illustration of a schematic of a direct thermal contact end-winding microchannel heat exchanger integrated within the windings in accordance with an embodiment of the present invention.

FIG. 10B is an illustration of the direct thermal contact end-winding microchannel heat exchanger in accordance with an embodiment of the present invention.

FIGS. 11A-11B are illustrations a comparison of motor length: (a) Original configuration without the microchannel heat exchanger; (b) Modified configuration incorporating the microchannel heat exchanger in accordance with an embodiment of the present invention.

FIG. 12A is a schematic illustration of mesh for finite element analysis (FEA) in accordance with an embodiment of the present invention.

FIG. 12B is an enlarged schematic illustration of a portion of mesh for finite element analysis (FEA) in accordance with an embodiment of the present invention.

FIGS. 13A-13D are illustrations of temperature distribution of the motor under various current densities using microchannel cooling: (a) 5.8 A/mm², (b) 14.6 A/mm², (c) 19.8 A/mm², and (d) 23.4 A/mm² in accordance with an embodiment of the present invention.

FIGS. 14A-14B are illustrations of: (a) two microchannel heat exchangers; (b) hairpin windings in accordance with an embodiment of the present invention.

FIG. 15 is an illustration of the actual test motor with end-winding microchannel heat exchangers after winding, showing the placement of surface-mount thermocouples on the end-windings and stator in accordance with an embodiment of the present invention.

FIG. 16 is an illustration of a block diagram of the actual experimental setup for the control tests in accordance with an embodiment of the present invention.

FIGS. 17A-17B are illustrations of motor thermography at 103 A (13.8 A/mm²) for both (a) non-cooling and (b) cooling scenarios in accordance with an embodiment of the present invention.

FIG. 18 is an illustration of measured temperatures at the positions indicated in FIG. 15 for the reference case, under a continuous current density of 12.6 A/mm² in accordance with an embodiment of the present invention.

FIG. 19 is an illustration of measured temperatures at the positions indicated in FIG. 15 for the case with microchannel heat exchangers integrated into the end-windings, under a continuous current density of 12.6 A/mm² in accordance with an embodiment of the present invention.

FIG. 20 is an illustration of thermocouple measurements at different locations with integrated microchannel cooling under 22.5 A/mm² continuous current density in accordance with an embodiment of the present invention.

FIG. 21 is an illustration of thermocouple measurements at different locations with integrated microchannel cooling under 24.8 A/mm² continuous current density in accordance with an embodiment of the present invention.

FIG. 22 is an illustration of temperature rise versus current density for different motor locations with microchannel cooling in accordance with an embodiment of the present invention.

FIG. 23 is an illustration of a modular assembly process for a hairpin-wound electric motor with integrated microchannel cooling in accordance with an embodiment of the present invention.

### DETAILED DESCRIPTION

Adjustable speed motor drives are an integral part of power train in electrified vehicles. There is a growing need for an increase in torque and power density in electric propulsion motors and their accompanying power converters. In order to achieve this in motors, an effective method for cooling of stator windings is necessary. Conventional cooling systems usually suffer from long thermal time constants in transfer of heat, complex arrangements for removal of heat from the windings leading to reduction of filling factor, and added volume and material. To address these shortcomings, an effective cooling system for stator windings of adjustable speed AC drives is proposed. This solution uses two-phase coolant materials and an embedded set of microchannels within the end windings for effective transfer of heat. The proposed design allows for effective usage of slot area for placement of the windings at a very high filling factor (75%) with high current density (up to 24 A/mm²). The integrated cooling and end-windings are separately designed enabling a modular assembly for the machine.

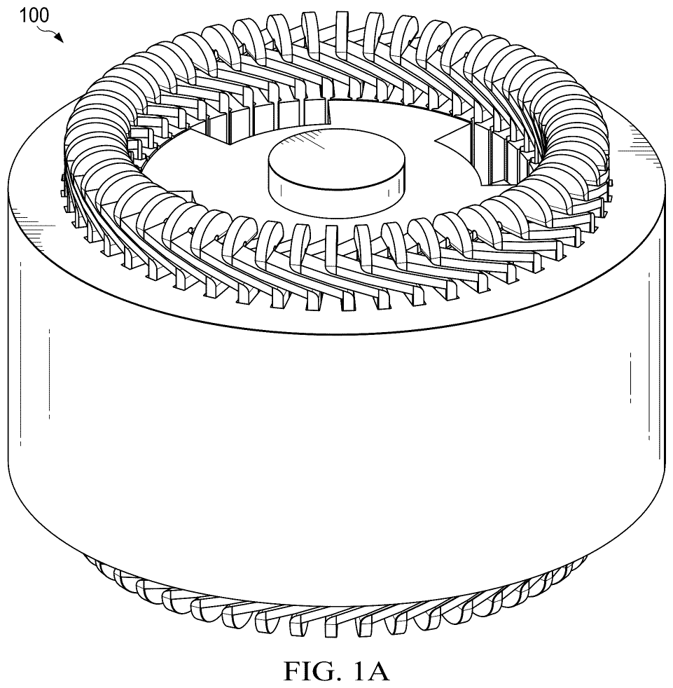

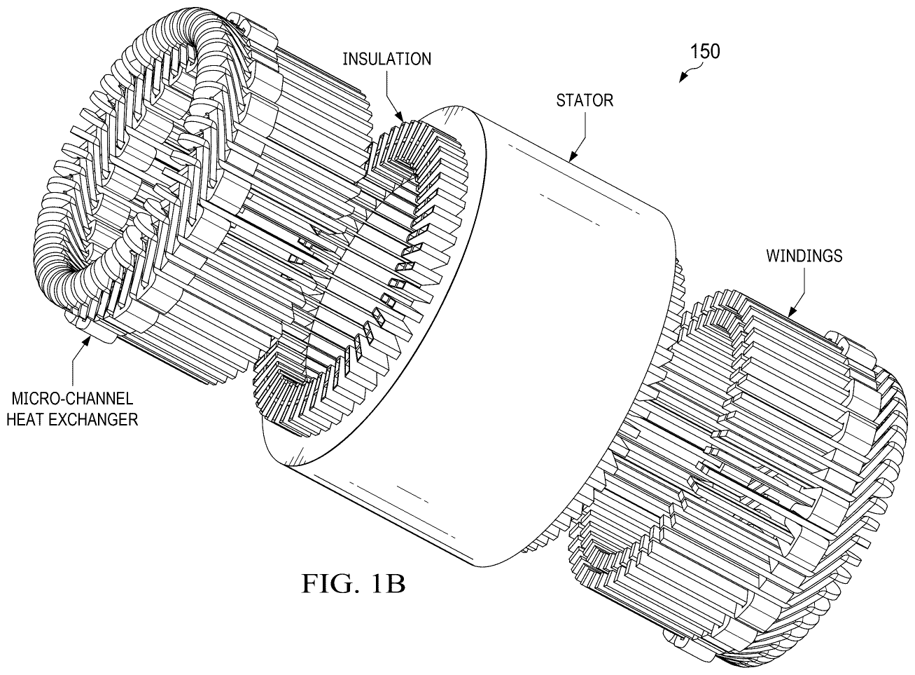

With reference now to the Figures, various embodiments of the present invention are illustrated. FIGS. 1A and 1B present the geometry of a motor (microchannel cooled electric machine) under study and its major dimensions (specifications are given in Table I). FIG. 1A shows an isometric view of a partially disassembled electric machine 100 where first and second modular direct thermal contact end-winding heat exchangers have been removed. FIG. 1B shows an exploded isometric view of an electric machine 150. First and second modular direct thermal contact end-winding heat exchangers including their associated windings are separated from stator and its associated insulation.

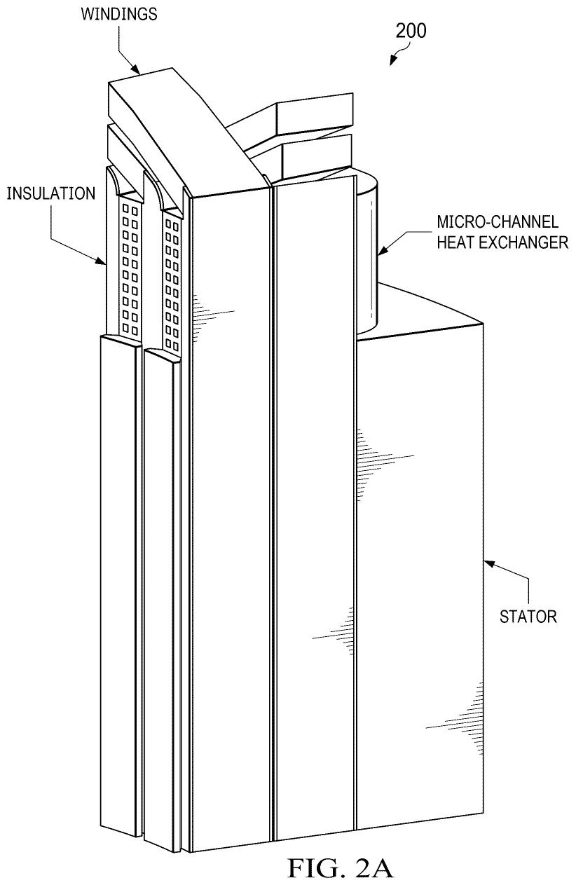

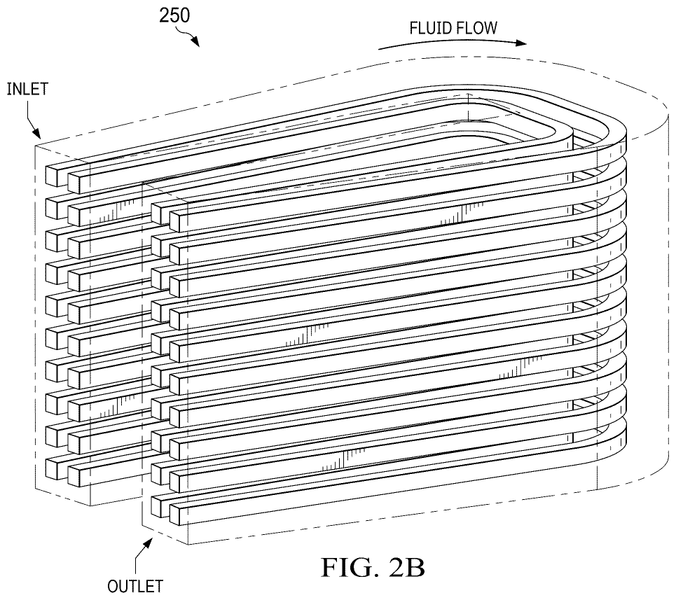

Embodiments can include an advanced cooling technique that involves integration of two-phase liquid-vapor containing microchannels with the end-windings, as depicted in FIGS. 2A-2B. This technique utilizes a heat exchanger known as a direct end-winding microchannel heat exchanger. FIGS. 2A-2B show an assembly 200 with microchannel heat exchanger shown a second time for clarity. The microchannel heat exchanger 250 incorporates 20 microchannels (with a spatial density of 0.2 microchannels per mm²), each featuring a cross-section of 1000 μm×1000 μm, facilitating the passage of a two-phase coolant within its confines. In high torque density machines, most thermal losses occur in the windings, typically dissipated through the stator to the frame and rejected to the ambient via air or water. The proposed micro-channel cooling system efficiently transfers the heat generated by the windings directly to a flowing fluid, leading to significant reduction of thermal resistance and enabling a substantial increase in current density while preserving the integrity of the winding insulation. Moreover, the proposed cooling system refrains from integrating a cooling pipe or exchanger within the slots, thereby facilitating the optimization of slot area utilization to achieve high filling factors.

TABLE 1
Motor Specifications

| Parameter | Value |
|---|---|
| Number of Slots | 48 |
| Current Density | up to 24 A/mm² |
| Power | up to 80 kW |
| Speed | 6000 rpm |
| Filling Factor | 75% |
| Poles | 8 |

### FEA Model

Temperature of an electric machine rises due to a variety of internal loss mechanisms. Each of these sources of heat has a different level of contribution depending on the operating point of the machine. Since stator core losses and winding copper losses are the main sources of heat in permanent magnet synchronous machines, the majority of this study has been performed on stator cooling. Utilizing finite element analysis (FEA), core and copper losses of the above machine are determined for various current density values, and the results are presented in Table 2.

TABLE 2
COPPER AND CORE LOSSES ON DIFFERENT
MACHINE OPERATING POINTS

| Current | Winding | | | | Copper | Core | Total |
|---|---|---|---|---|---|---|---|
| Density (A/ | Current (A, | Speed | Torque | Power | Loss | Loss | Loss |
| mm²) | RMS) | (RPM) | (N.m.) | (kW) | (kW) | (kW) | (kW) |
| 3 | 49.72 | 6000 | 3.4 | 2.13 | 0.182 | 0.477 | 0.659 |
| 12 | 199 | 6000 | 65.4 | 41.1 | 2.91 | 1.6 | 4.51 |
| 24 | 397.8 | 6000 | 124 | 77.91 | 11.6 | 2.31 | 13.9 |

### Direct End-Winding Microchannel CFD Model

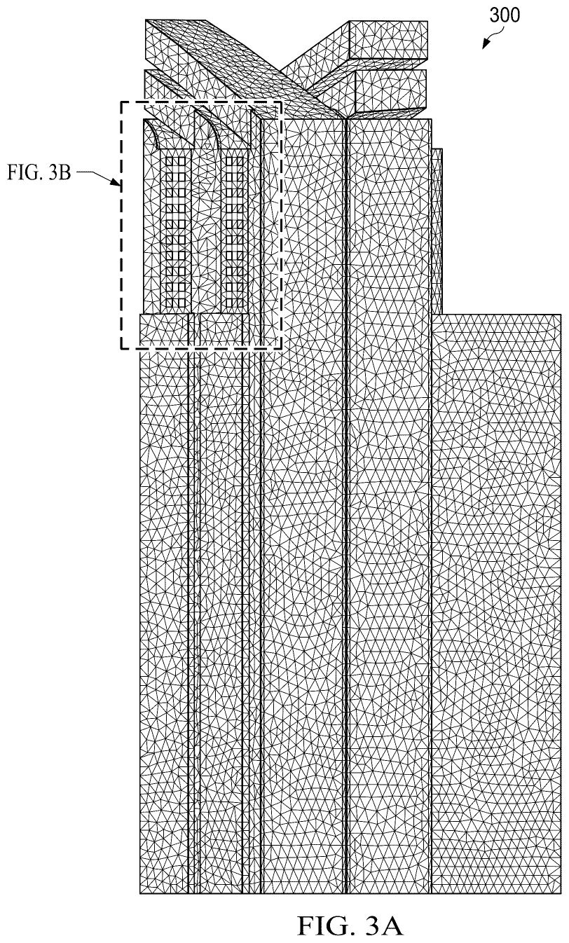

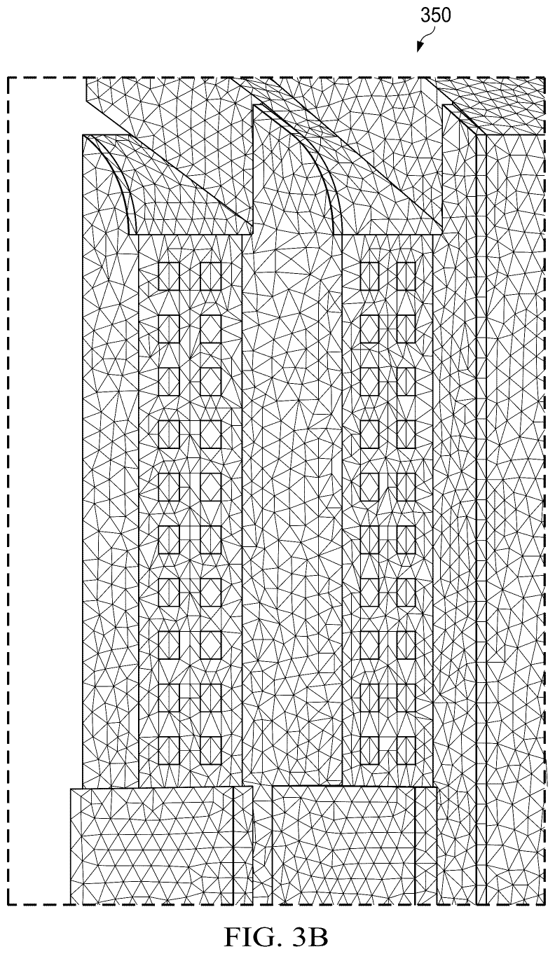

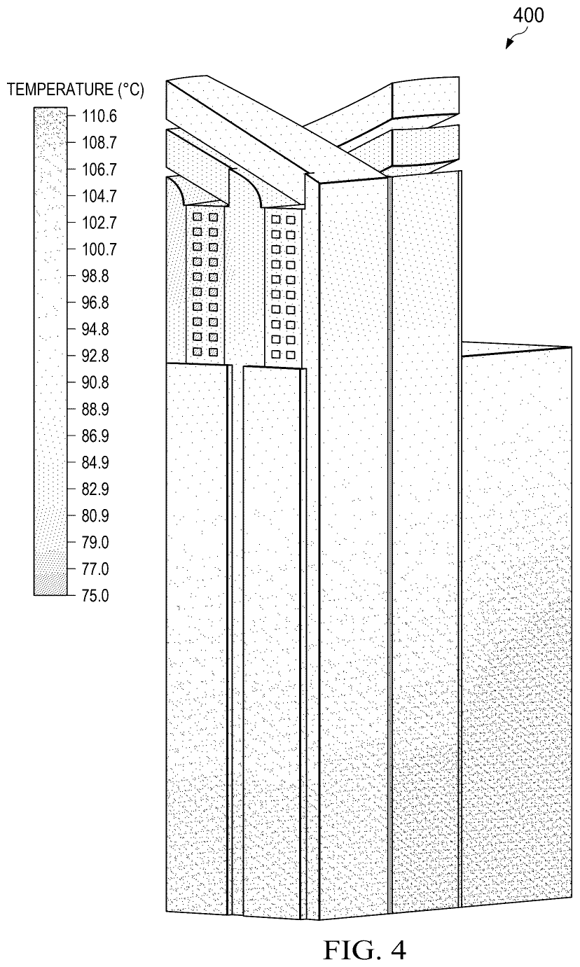

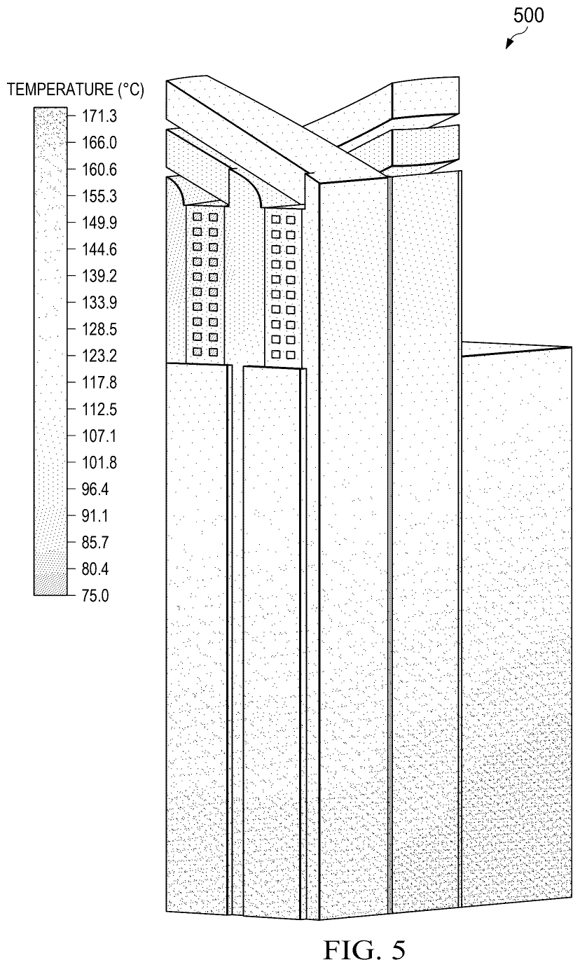

The FEA and computational fluid dynamics (CFD) with conjugate heat transfer were used to calculate the temperature distribution within the motor. Temperature analysis was conducted for half of the two coils of the motor, considering its symmetrical structure. FIGS. 3A-3B display two images of the FEA model mesh, with a consistent average mesh size set at 0.7 mm. First image 300 includes a portion of FEA model mesh 350 that is shown magnified for clarity. Given the inherent benefits of two-phase fluid, such as elevated heat transfer rates, diminished pressure drops, and reduced temperature gradients along the flow direction, the proposed microchannel cooling system employed two-phase fluid flow over single-phase fluid for optimal performance. A 75° C. inlet fluid temperature with total fluid flow rate of 12 L/min was selected to allow for boiling and enhance heat transfer rate. This was achieved by introducing a two-phase fluid (a mixture of water and vapor) into the microchannels. Resulting temperature distribution of the windings, core, and microchannels for two different current densities are shown in FIGS. 4 and 5. Thermal analysis results 400 in FIG. 4 and thermal analysis results 500 in FIG. 5 show that the highest temperature with 12 and 24 A/mm² current density and 75% filling factor was 110.6° C. and 171.3° C. using microchannel cooling, respectively.

Comparison with Water Jacket

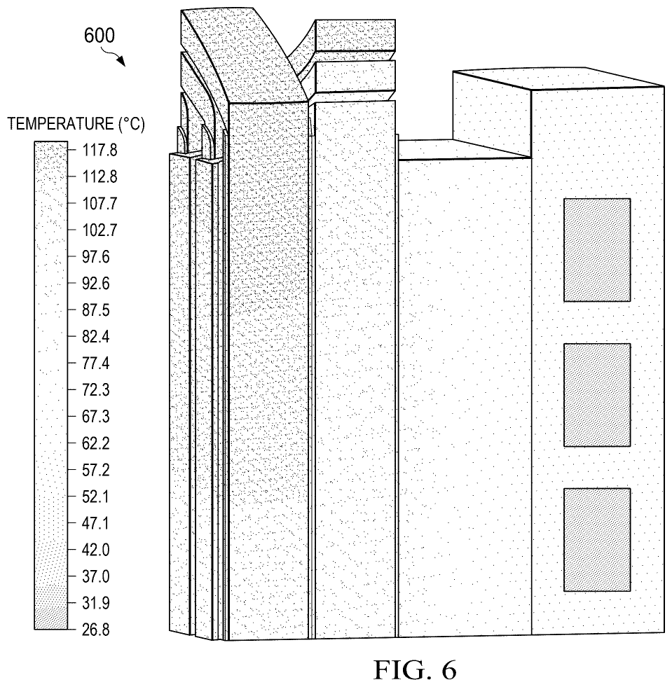

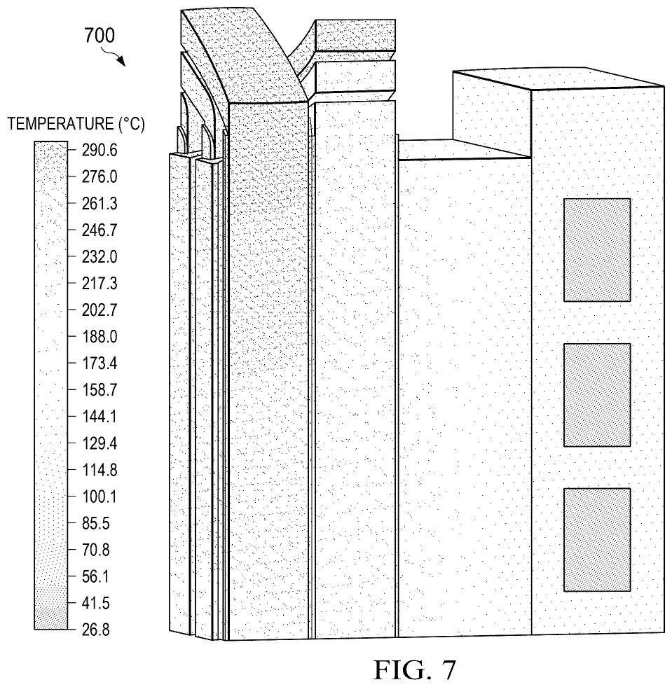

To assess the efficacy of the proposed cooling system, a comparative thermal analysis (i.e., with the same total fluid flow rate of 12 L/min and using the same coolant) was conducted with the conventional water jacket cooling. FIGS. 6 and 7 depict the temperature distribution of the windings, core, and water jacket under various current densities when employing water jacket cooling which has 25° C. inlet fluid temperature. Thermal analysis results 600 in FIG. 6 and thermal analysis results 700 in FIG. 7 show that the highest temperature with 12 and 24 A/mm² current density and 75% filling factor is 117.8° C. and 290.6° C. using water-jacket cooling, respectively. Comparing the thermal results in FIGS. 4 and 6, it is evident that, for current density of 12 A/mm², the microchannel cooling system results in a reduction of 7.2° C. in the maximum temperature compared to the water-jacket cooling system. Comparing thermal results in FIGS. 5 and 7 for current density of 24 A/mm², indicates that microchannel cooling system achieves a substantial reduction of 119.3° C. in maximum temperature compared to water-jacket cooling.

Embodiments enable an efficient cooling approach using an effective heat exchanger (the direct end-winding microchannel heat exchanger). This technique integrates microchannels with two-phase coolant within the end-windings, facilitating the slot area utilization for high filling factors and accommodating elevated current densities. In contrast to conventional water-jacket cooling, the disclosed method demonstrates superior effectiveness in cooling the motor, particularly at higher current densities.

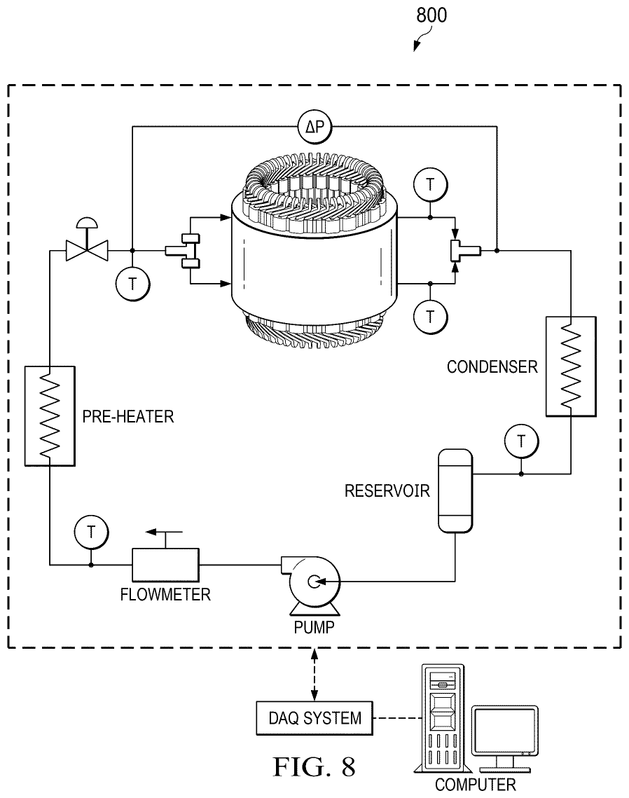

In the embodiment shown in FIG. 8, the cooling system 800 comprises an input manifold for receiving liquid coolant from the cooling system (cold side) into the microchannel heat exchanger and an output manifold from the microchannel heat exchanger to the cooling system (hot side) for exhausting vaporized coolant to the cooling system; the cooling system comprising a condenser connected to a reservoir, a coolant pump for pumping liquid coolant from the reservoir to a preheater and expansion valve along with a flow meter and a set of temperature sensors at points shown in the diagram to monitor and control the cooling system with an external controller. FIG. 8 is to be considered a non-limiting example of a type of cooling system that will interoperate with the microchannel cooled electric machine. In other embodiments, many coolants and other types of cooling systems may be configured to interoperate with the microchannel heat exchanger in a microchannel cooled electric machine.

The disclosed technology enables the development of high-performance electric propulsion motors with increased torque and power density, making them ideal for use in electric vehicles such as electric cars, buses, trucks, and even electric aircraft. Also, the cooling system proposed in our technology can also be integrated into power converters associated with electric propulsion systems. These converters play a crucial role in converting electrical energy efficiently, and the disclosed cooling solution enhances their performance and reliability. Moreover, this innovative cooling system, with its two-phase coolant materials and embedded microchannels, can be packaged as standalone modular units suitable for integration into various motor designs and configurations. The modular cooling systems disclosed herein may be marketed to manufacturers of electric motors and powertrain components.

Adjustable speed motor drives are crucial components of the powertrain in electrified vehicles. With the increasing demand for higher torque and power density in electric propulsion motors and their associated power converters, efficient cooling methods for stator windings are essential. Traditional cooling systems often face challenges, including long thermal time constants for heat transfer, complex configurations for heat removal from the windings, which result in reduced filling factors, and the added volume and material requirements. To overcome these limitations, a novel cooling system for the stator windings of adjustable-speed AC drives can be included in embodiments of this description. This system incorporates embedded microchannels within the end windings to facilitate efficient heat transfer. The design allows for the effective utilization of the slot area, enabling the placement of windings at a very high filling factor, while accommodating high current density. The cooling system and end windings are designed and developed separately, enabling a modular assembly of the machine. This modular approach offers significant advantages in terms of ease of repair and recycling.

Embodiments can include an advanced and highly effective cooling solution tailored for the stator windings of adjustable-speed AC drives used in electric propulsion systems. The approach enables superior thermal performance by directly targeting the primary heat sources-particularly the end-windings—where thermal stress is typically the highest. The design features a set of embedded microchannels intricately integrated within the end-windings, allowing for efficient heat extraction by establishing direct contact between the coolant pathway and the heat-generating regions. This close thermal coupling significantly reduces the thermal resistance and enables rapid heat transfer, thereby improving overall system reliability and longevity. Moreover, the cooling system supports optimal utilization of the stator slot area, facilitating the placement of conductors at a very high filling factor while sustaining high current density levels (up to 24 A/mm²). Unlike conventional systems that often compromise slot fill and introduce bulky configurations, this solution leverages a compact and space-efficient architecture, preserving the electromagnetic performance while enhancing thermal dissipation.

A key innovation of this design lies in its modular structure—where the cooling system and end-windings are developed and assembled as separate units. This modularity simplifies the overall assembly process and offers significant advantages in terms of ease of repair, component replacement, and end-of-life recycling. By combining high thermal efficiency, mechanical simplicity, and adaptability, the design addresses the pressing challenges of thermal management in the next-generation of high-performance electric machines, enabling higher power density without compromising reliability or manufacturability.

### Cooling Method

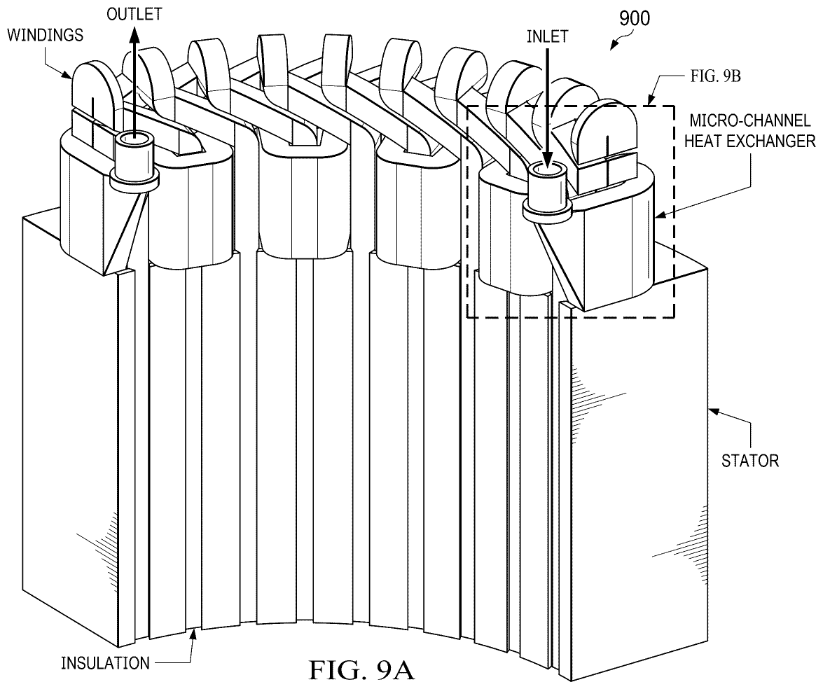

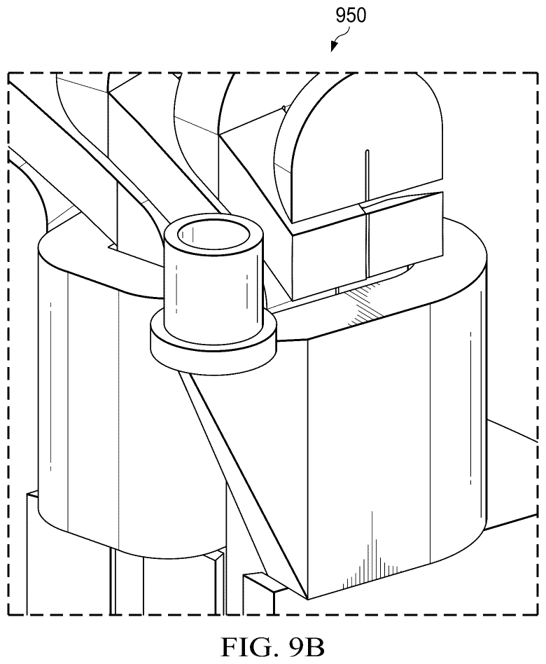

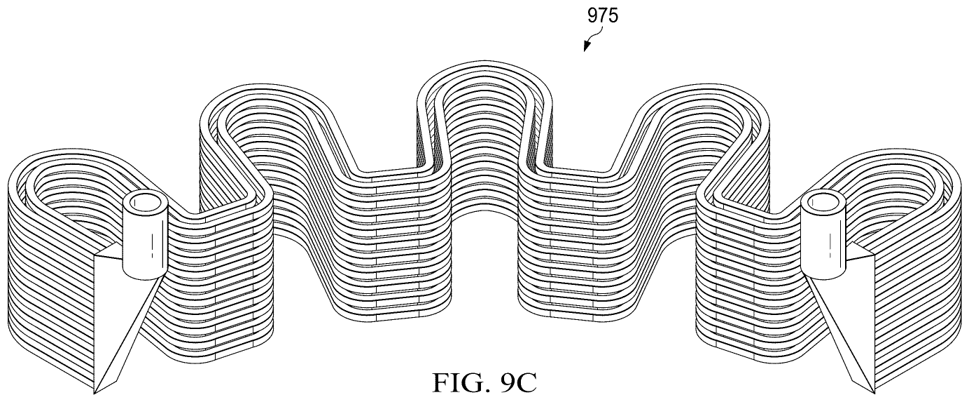

Referring to FIGS. 9A-9C, the cooling technique of this description can be manifested in an embodiment 900 integrating a microchannel heat exchanger 975 directly with the motor's end-windings. View 950 shows the inlet of the microchannel heat exchanger in context with the windings, stator and insulation. The heat exchanger used in this system is referred to as a direct end-winding microchannel heat exchanger. In high-torque-density electric machines, the majority of thermal losses are generated in the windings, with end-windings being particularly prone to hotspots due to their higher thermal resistance with the surrounding cooling medium. Traditionally, heat from the windings is dissipated through the stator to the frame and rejected to the ambient via air or water. The microchannel heat exchanger transfers heat generated in the end-windings directly to a passing coolant, significantly reducing the thermal resistance between the windings and the ambient. This allows for a substantial increase in current density while maintaining the thermal integrity of the winding insulation. The design incorporates 20 microchannels with a spatial density of 0.23 microchannels per mm². Each microchannel has a cross-sectional area of 760 μm×760 μm, optimized for efficient heat transfer.

The fluid flows through the microchannels in a controlled manner to extract heat directly from the end-windings, bypassing the traditional reliance on stator heat dissipation. This ensures a lower thermal resistance path while eliminating the need for incorporating cooling pipes or exchangers within the winding slots. As a result, the slot area can be fully utilized for achieving higher winding filling factors, enhancing the motor's power density and efficiency.

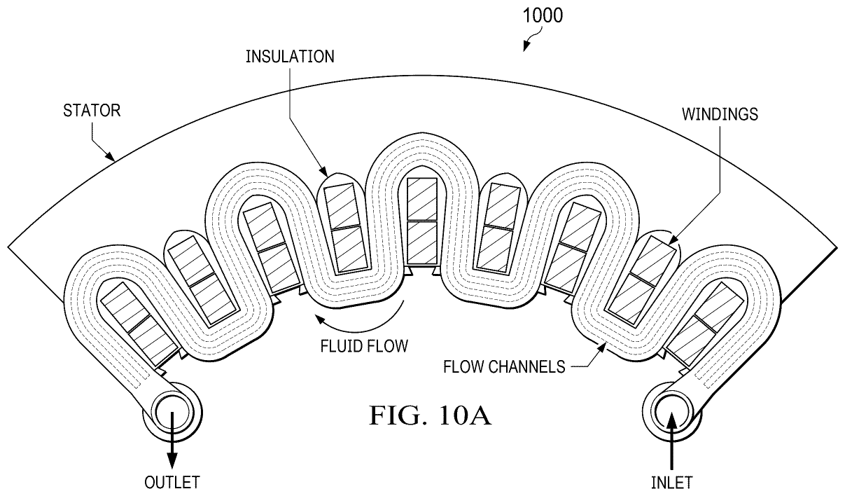

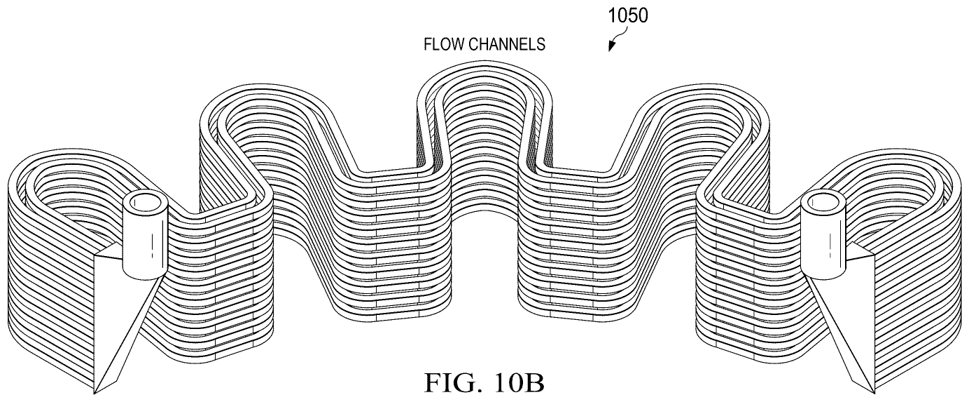

Microchannels can provide optimal balance between minimal pressure drop and maximal heat transfer, yielding impressive heat transfer coefficients reaching up to 50,000 W/m²·K. The fluid flows radially through the direct end-winding microchannel heat exchanger, as shown in embodiment 1000 of FIGS. 10A-10B. Thes figures also illustrates the inlet, outlet, and the integration of the microchannel heat exchanger 1050 within the winding structure.

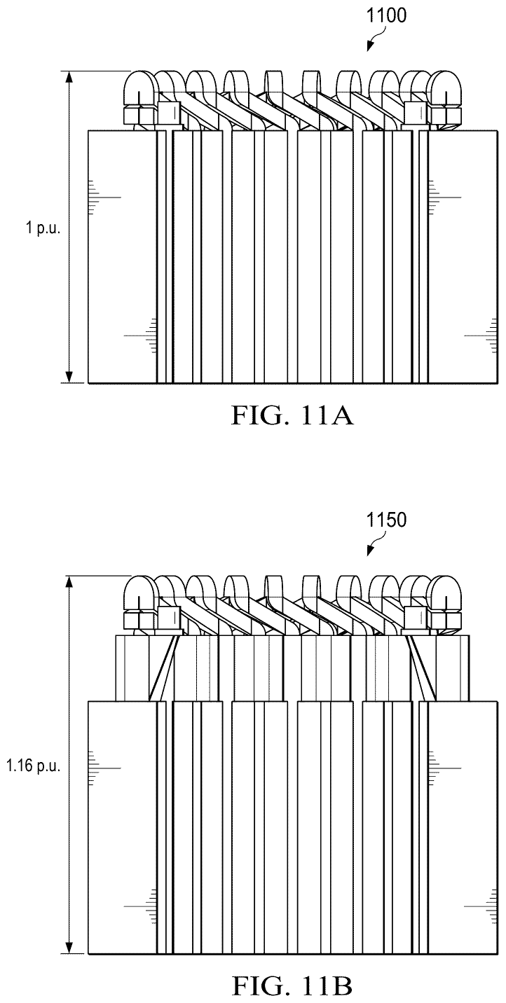

To optimize the heat exchange surface and thereby improve the efficiency of the microchannel cooling, it is important to deliberately elongate the axial section of the end-windings. In the case of the analyzed machine, this required an extension of the axial portion of the machine's length by a factor of 1.16, corresponding to an approximate increase of 15.7 mm compared to the original length of the machine. This modification is depicted in detail in FIGS. 11A-11B, highlighting the necessary adjustments made to enhance the overall cooling performance. An end 1150 includes a plurality of windings coupled to the plurality of insulators, located at least partially within and surrounded by the plurality of insulators, and extending beyond the first end. Another end 1100 does not include windings that extend beyond the second end. In preferred embodiments, both ends can include a plurality of windings coupled to the plurality of insulators, located at least partially within and surrounded by the plurality of insulators, and extending beyond the first end.

### Thermal Finite Element Model

### The 3D Quarter Stator Pole Model

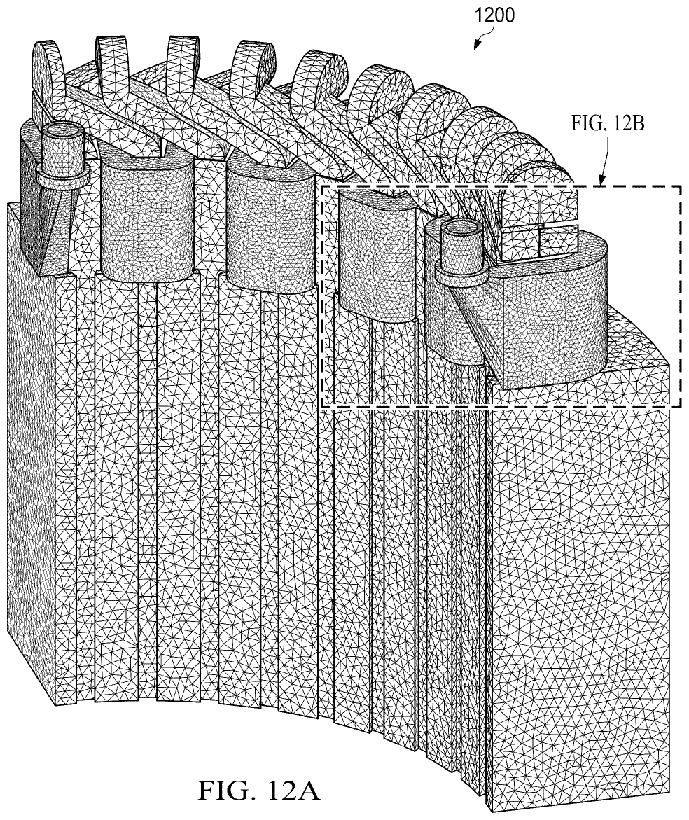

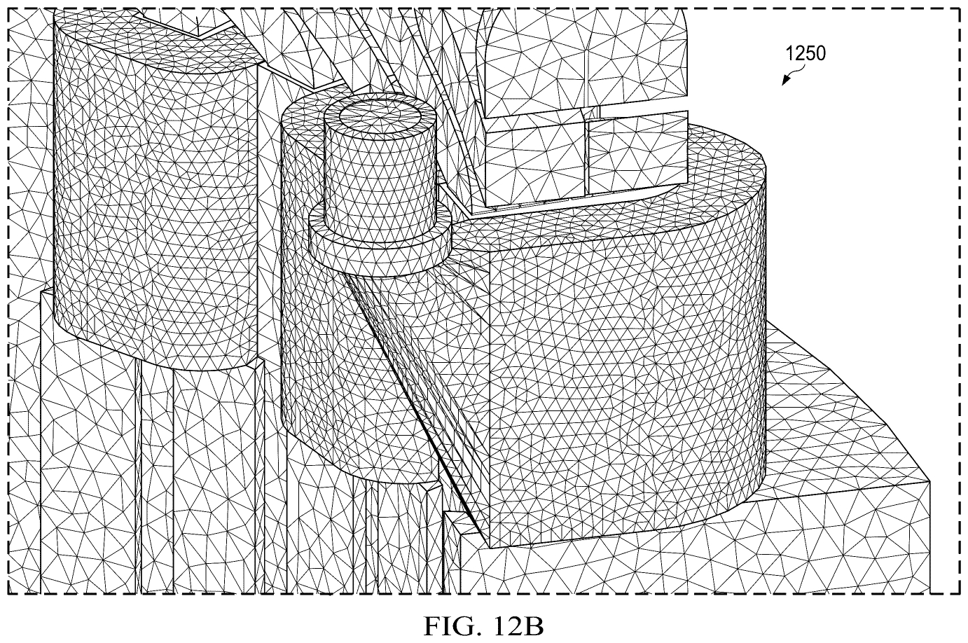

To assess the performance of the direct end-winding microchannel cooling and to visualize and analyze the temperature distribution within the stator pole, a 3D thermal finite element model was developed. Due to thermal symmetry, only a quarter of the stator pole needed to be modeled. The schematic representation of the modeled geometry is shown in FIGS. 12A-12B. These figures includes two images of the FEA model mesh, a larger scale image 1200 and a smaller scale image 1250, both featuring a uniform average mesh size of 0.7 mm.

### Direct End-Winding Microchannel CFD Model

The FEA and computational fluid dynamics (CFD) with conjugate heat transfer were used to calculate the temperature distribution within the motor. FEA is primarily employed for solving conductive heat transfer, dividing the motor's solid domain into small elements. By approximating the general heat equation with weak functions, a linear system of equations is derived in (1), ensuring accurate temperature distribution even with highly intricate geometries.

$$ρ {c}_{p} \frac{\partial T}{\partial t} = ∇ \cdot k ∇ T + {q}_{V} \qquad ( 1 )$$

where cₚ is the specific heat of the solid, ρ is the mass density of the solid, q_{V} is the volumetric heat source and k is the thermal conductivity of the solid. Additionally, FEA offers the advantage of direct coupling with a model solving for magnetic flux density in the same region as the thermal analysis. This coupled approach has been widely adopted in research. When exclusively utilizing conductive models with FEA, convective heat transfer at solid-fluid interfaces is typically determined by combining Newton's law of cooling given in (2) with convection correlations to ascertain the heat transfer coefficient (h).

$$q = hA ( {T}_{s} - {T}_{f} ) \qquad ( 2 )$$

where A denotes the heat transfer area, T_{f} is the temperature of the fluid, and Tₛ represents the temperature of the solid at the interface. CFD models employing conjugate heat transfer dispense with the need for such correlations, as both solid and fluid domains are comprehensively solved. The entire fluid domain is segmented into elementary cells, corresponding to a controlled volume in the finite volume method. Within each cell, the continuity, momentum, and energy equations are resolved, facilitating the derivation of the heat transfer coefficient at the fluid-solid interface without relying on convective correlations. Furthermore, CFD models prove beneficial in scenarios of highly intricate fluid flow paths, such as in the end-winding region.

### CFD Simulation Results

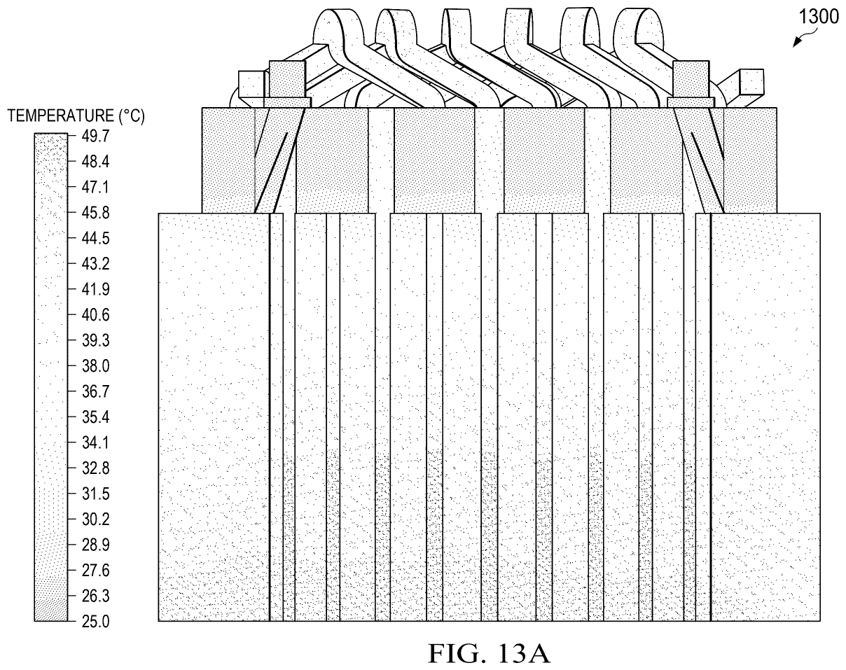

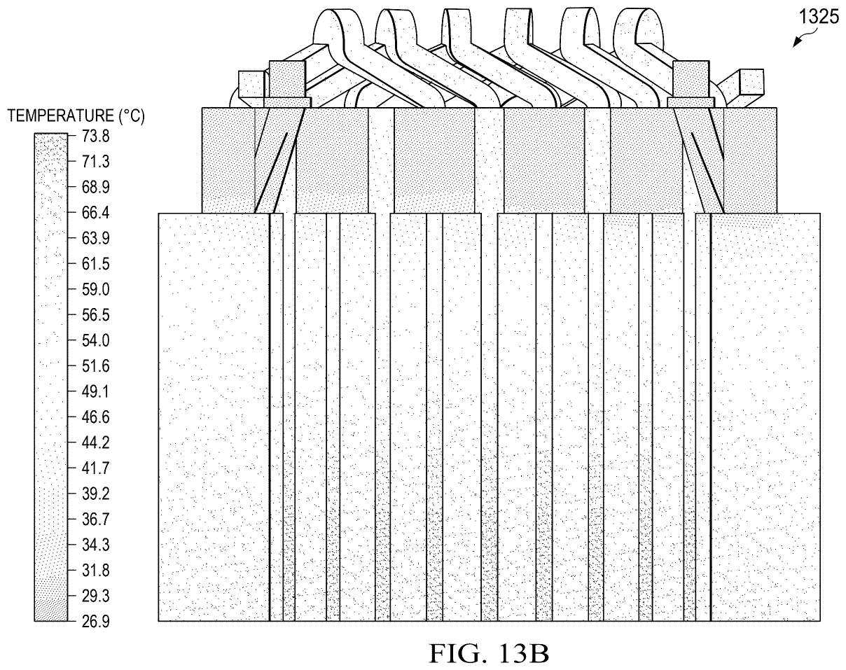

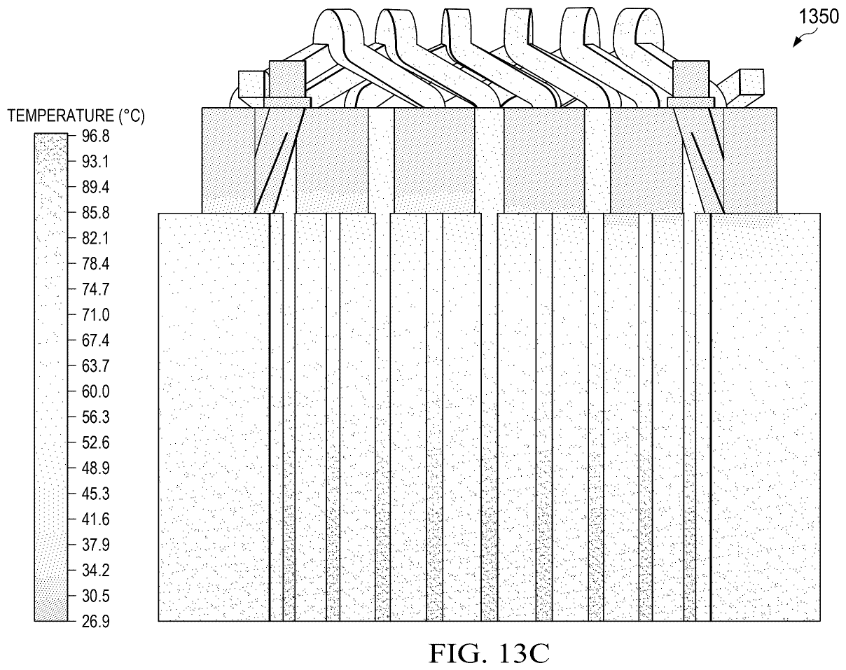

Temperature analysis was performed on one-eighth of the motor geometry, leveraging its symmetrical structure to reduce computational complexity. The steady-state thermal results obtained from the FEA with a coolant flow rate of 3.25 L/min at current densities of 5.8, 14.6, 19.8, and 23.4 A/mm² are presented in FIGS. 13A-13D. At a current density of 5.8 A/mm² 1300, the maximum temperature reaches 49.7° C. near the center of the motor. Additionally, the temperature at the end-winding region is observed to be approximately 44° C. This relatively lower temperature is attributed to the placement of the microchannel heat exchanger, which is interwoven with the end-windings, thereby enhancing the cooling efficiency in that region.

As the current density increases, the motor experiences a significant rise in temperature, particularly near its center. At a current density of 14.6 A/mm² 1325, the maximum temperature reaches approximately 73.8° C. at the center of the motor, while the temperature at the end-winding region is around 62° C. When the current density is increased to 19.8 A/mm² 1350, the peak temperature climbs to 96.8° C. in the middle of the motor, with the end-winding temperature recorded at approximately 82° C. At the highest evaluated current density of 23.4 A/mm² 1375, the central region reaches a maximum temperature of 119.8° C., and the end-winding region registers about 102° C. In all cases, the central region consistently exhibits the highest thermal stress due to localized heat accumulation. However, the end-winding area remains relatively cooler, which can be attributed to the effective cooling action of the microchannel heat exchanger integrated near this region. These findings clearly illustrate the increasing thermal demand under higher current densities and the critical role of enhanced cooling solutions in maintaining thermal stability.

TABLE 3
Motor Specification

| Parameter | Value | |
|---|---|---|
| Frame diameter | 170 | mm |
| Frame length | 167 | mm |
| Stator outer Diameter | 108 | mm |
| Stator inner Diameter | 92 | mm |
| Stator stack length | 123 | mm |
| Stator tooth width | 4.9 | mm |

| | |
|---|---|
| Number of Slots | 36 |
| Number of Poles | 4 |

### Experimental Verification of the Thermal Methodology

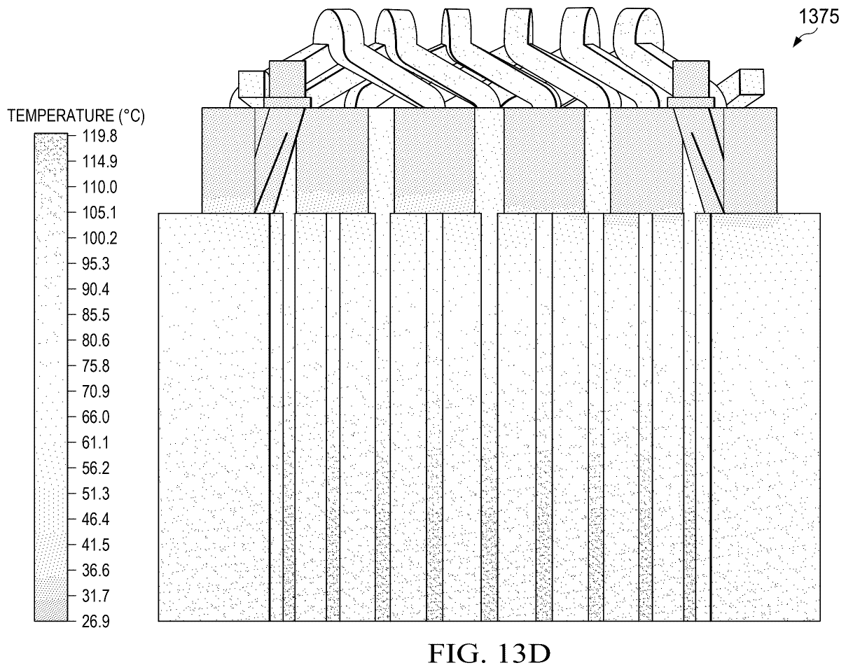

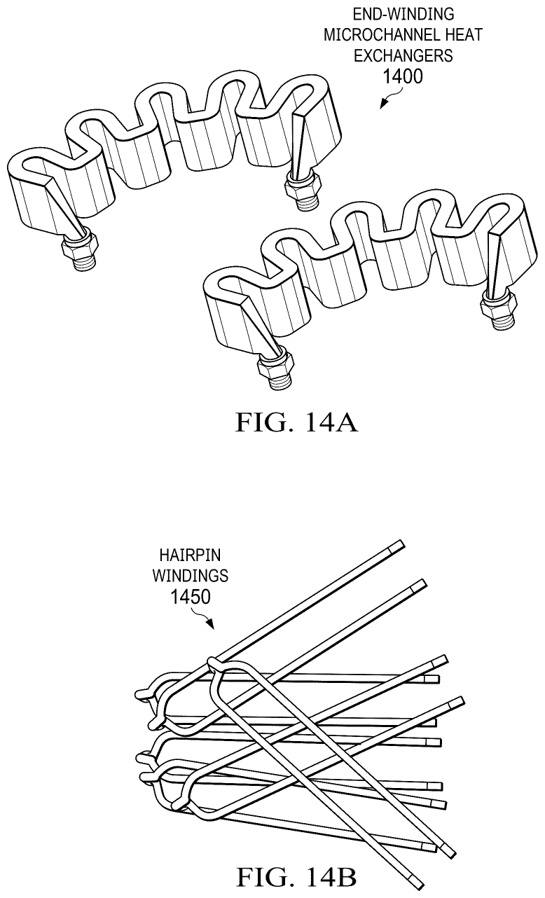

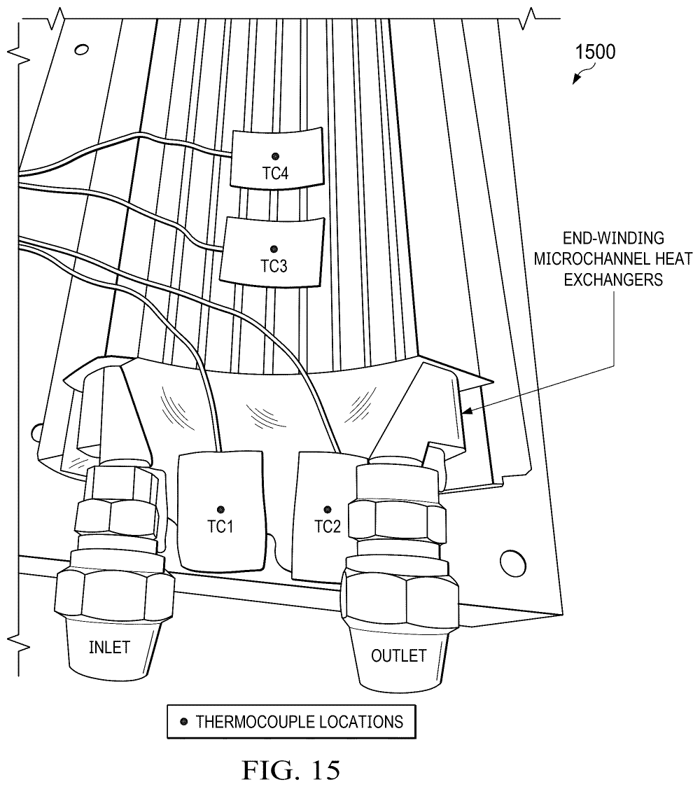

To experimentally validate the concept, a stator of an existing electric machine is utilized as the test platform. The geometrical dimensions and key machine specifications are detailed in Table 3. The fabricated end-winding microchannel heat exchangers and hairpin windings are shown in FIGS. 14A-14B. FIG. 14A shows 2 modular end-winding microchannel heat exchangers 1400. These can be combined to equip half of one end of a stator, or a quarter of each of two ends of a stator. Eight of these modular end-winding microchannel heat exchangers 1400 can fully equip both ends of a stator. To investigate the direct end-winding microchannel heat exchanger, a quarter section of the original four-pole electric machine was constructed and wound using hairpin windings 1450 with 15.7 mm extended end-winding lengths to accommodate the heat exchanger. A portion of the assembled test motor 1500, featuring potted windings using a high-thermal-conductivity epoxy, is shown in FIG. 15. The epoxy ensures good thermal contact between the end-winding microchannel heat exchangers and the windings. To capture detailed thermal performance, four K-type surface-mounted thermocouples were strategically placed on the stator, end-windings, and the microchannel heat exchanger, as indicated by the dots in FIG. 15. These sensors provide accurate temperature measurements critical for validating the thermal behavior of the system. The tested segment of the machine comprises nine slots populated with hairpin windings. A single layer of (e.g., Nomex) insulation paper was employed as a slot liner to ensure galvanic isolation between the coils and the stator core. The resulting slot fill factor is approximately 0.55. The windings were energized using a DC power supply, allowing for controlled generation of DC copper losses, which simplifies loss quantification during the testing phase.

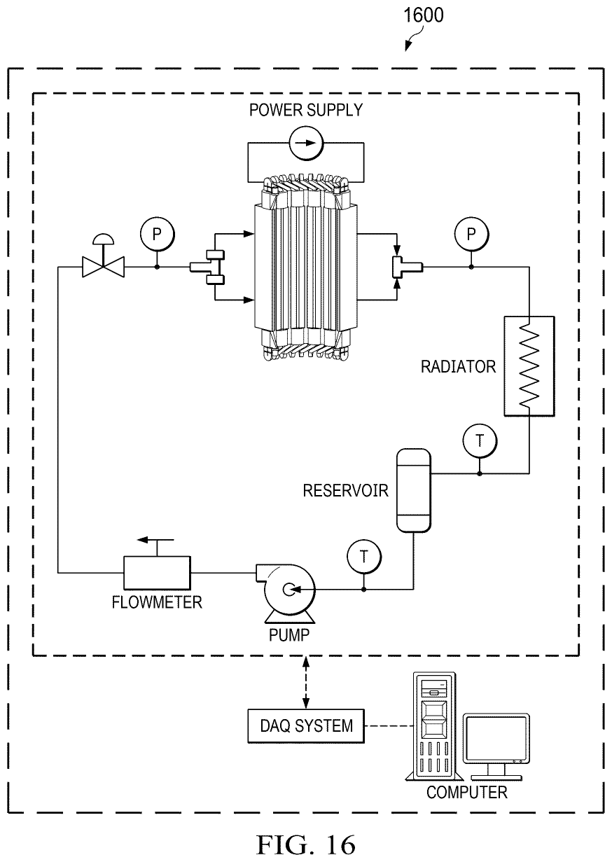

Turning to FIG. 16, the experimental setup 1600 included a motor (WEG Motor), a pump, a radiator, a flowmeter, two pressure meters, a resistive load bank, K-type thermocouples, and a data acquisition (DAQ) system. The DAQ system includes a thermocouple module (NI 9213). The stator current was measured using an oscilloscope (Tektronix TPO 3014) and a current probe (Tektronix TCP404XL).

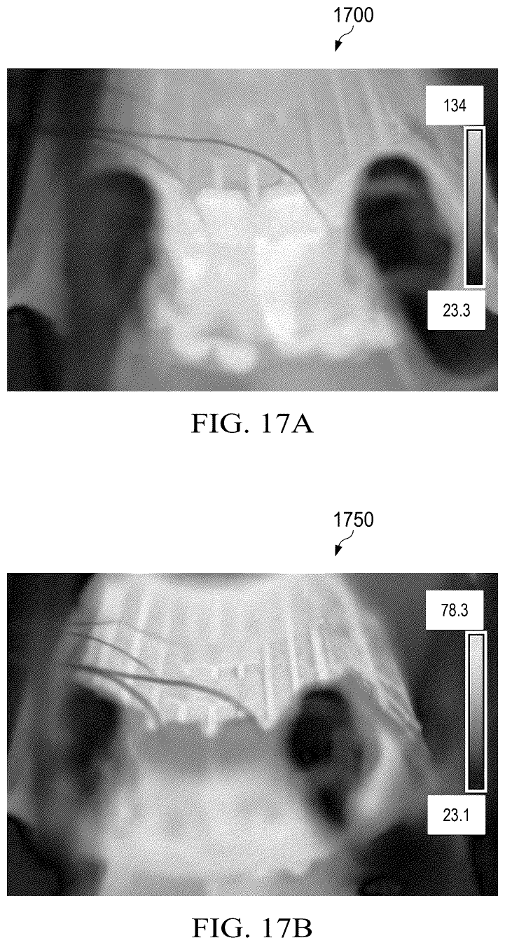

The motor winding insulation is rated for a maximum temperature of 155° C., corresponding to Class F insulation. This value was considered the upper allowable limit to prevent insulation damage or reduced lifespan. FIGS. 17A-17B presents the thermographic images for both cooling and non-cooling scenarios at 103 A DC current. Under the first configuration 1700 (without cooling), a DC current of 103 A resulted in a steady-state end-winding temperature of 134° C., which corresponds to approximately 84% of the Class F insulation limit. Under the second configuration 1750 (with cooling), when end-winding cooling was applied at the same current level, the temperature decreased to 78.3° C., representing a temperature reduction of about 42.6%. For validation, a second temperature measurement was performed using a thermal camera, confirming the accuracy of the thermocouple readings.

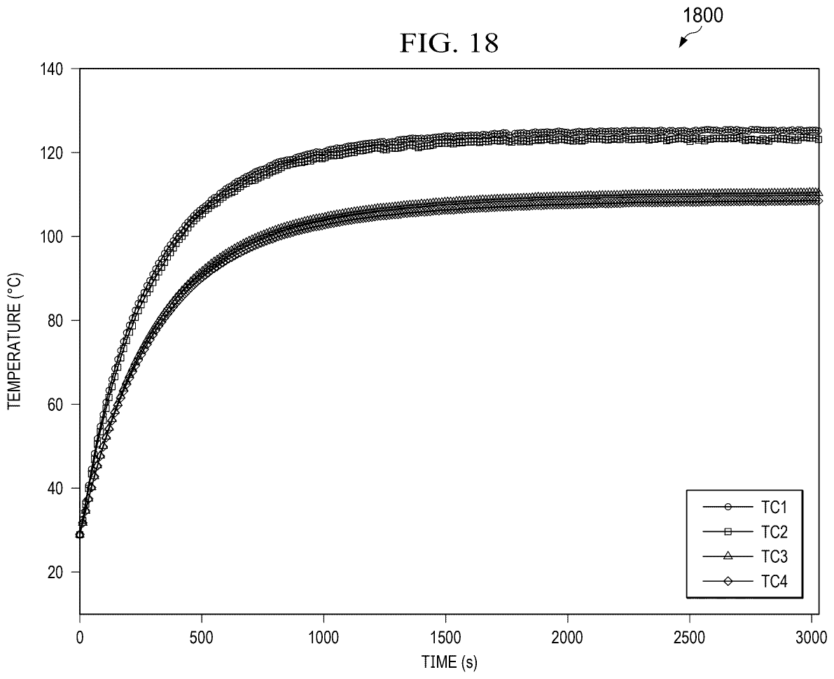

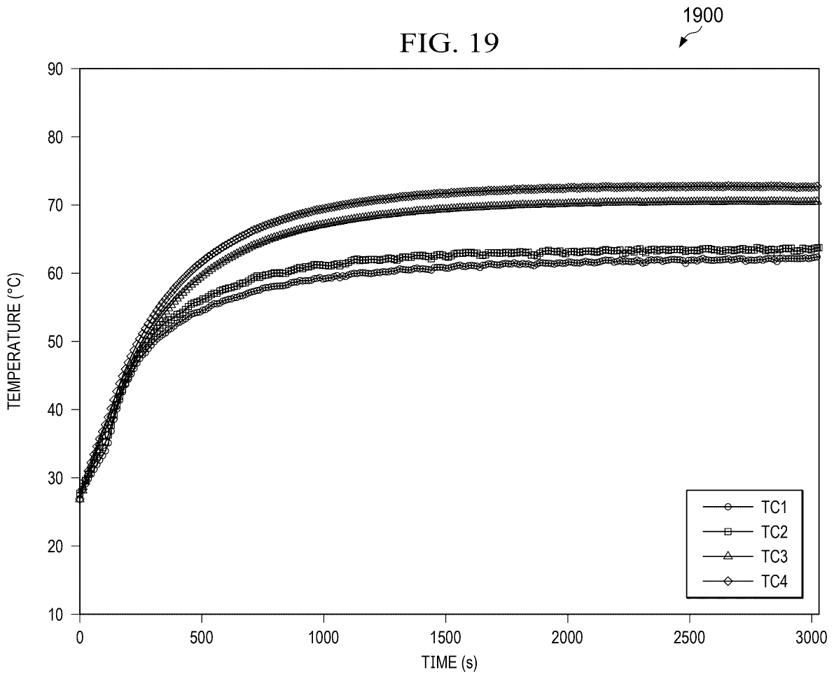

FIGS. 18 and 19 illustrate the measured temperature profiles at four key locations identified in FIG. 15 (i.e., TC1, TC2, TC3, TC4), under a continuous current density of 12.6 A/mm². These results reflect the transient thermal behavior from startup to steady-state conditions at 3000 seconds. FIG. 18 shows the temperature distribution for the reference case, where no coolant is circulated through the microchannel heat exchangers 1800. In this configuration, high temperatures are observed throughout the motor. Specifically, the temperature at end-winding point 1 (TC1) reaches 125.4° C., while end-winding point 2 (TC2) records 123.5° C. In the stator region, stator point 1 (TC3) reaches 110.4° C., and stator point 2 (TC4) shows 108.8° C. These elevated values indicate considerable thermal stress in the absence of active cooling. FIG. 19, on the other hand, presents the thermal response when microchannel heat exchangers are integrated into the end-windings and coolant is circulated through the microchannel heat exchangers 1900. This results in a significant reduction in temperature across all measured points. Under this configuration, end-winding point 1 (TC1) drops to 62.2° C., and end-winding point 2 (TC2) to 63.5° C. Similarly, stator point 1 (TC3) and stator point 2 (TC4) exhibit reduced temperatures of 70.3° C. and 72.5° C., respectively. This comparison clearly demonstrates the effectiveness of the microchannel cooling strategy, providing substantial thermal relief to both the end-winding and stator regions, and significantly enhancing the motor's thermal performance and operational reliability.

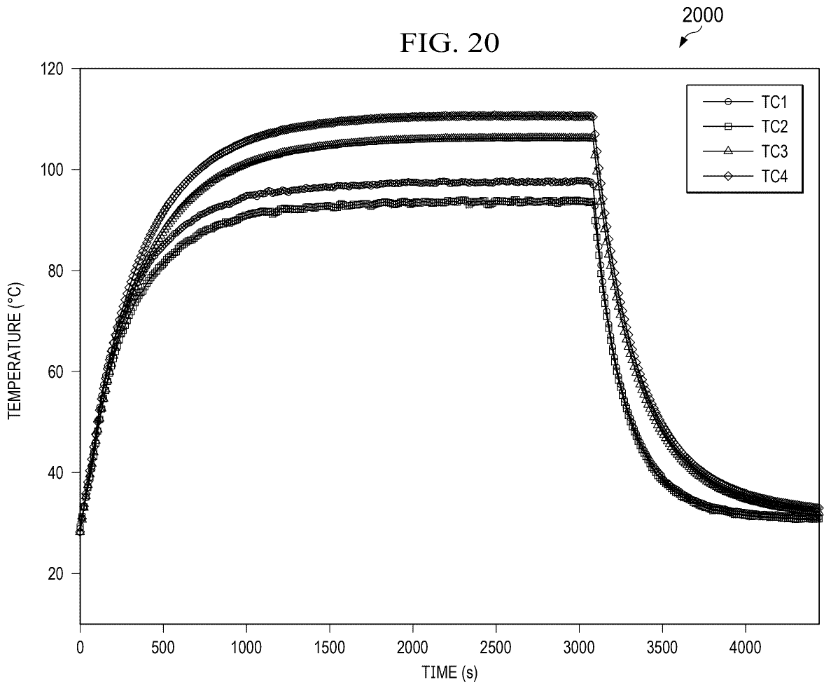

FIG. 20 illustrates the steady-state temperature distribution measured by thermocouples placed at four critical locations within the motor 2000, when operating under a continuous current density of 22.5 A/mm² with integrated microchannel cooling. The temperature at end-winding point 1 (TC1) is recorded at 94.4° C., while end-winding point 2 (TC2) shows a similar value of 93.5° C. In the stator region, point 1 (TC3) reaches 106.2° C., and point 2 (TC4) exhibits the highest temperature at 110.5° C. These results reflect the thermal performance of the system when subjected to a high electrical load. While all measured points show elevated temperatures due to the increased current density, the thermal conditions remain well managed and below critical thresholds. The close temperature values between the two end-winding locations suggest consistent and uniform cooling performance, while the stator temperatures indicate localized heating that is still effectively constrained by the microchannel cooling configuration.

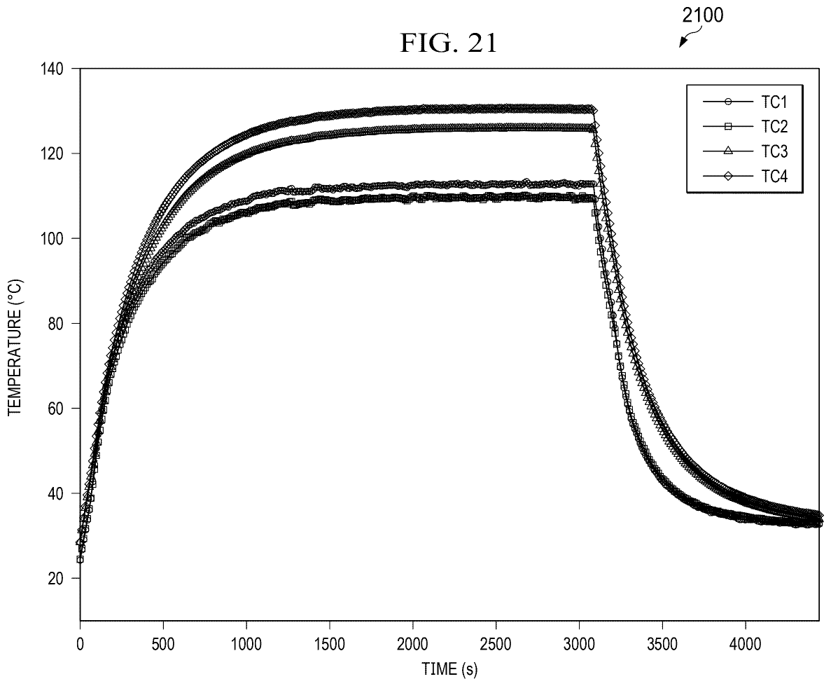

FIG. 21 presents the measured temperatures at four monitored locations within the motor 2100, when operating under a continuous current density of 24.8 A/mm², with microchannel cooling actively integrated into the system. Under this high current density, the temperature at end-winding point 1 (TC1) reaches 112.8° C., while end-winding point 2 (TC2) records 109.5° C. In the stator region, point 1 (TC3) exhibits the highest temperature at 130.4° C., followed by point 2 (TC4) at 125.8° C. This set of measurements demonstrates the thermal behavior of the motor under extreme electrical loading. While temperatures are elevated—as expected at such high current densities—the cooling system continues to regulate the heat effectively. The slightly higher temperatures in the stator compared to the end-windings suggest that the thermal load is more concentrated in the core regions during peak operation. Nevertheless, the temperature gradient remains consistent, and the values indicate that the microchannel heat exchangers provide substantial cooling support even in demanding scenarios. These findings validate the microchannel system's capability to operate under intense thermal stress, confirming its potential for use in high-performance and power-dense electric drive systems.

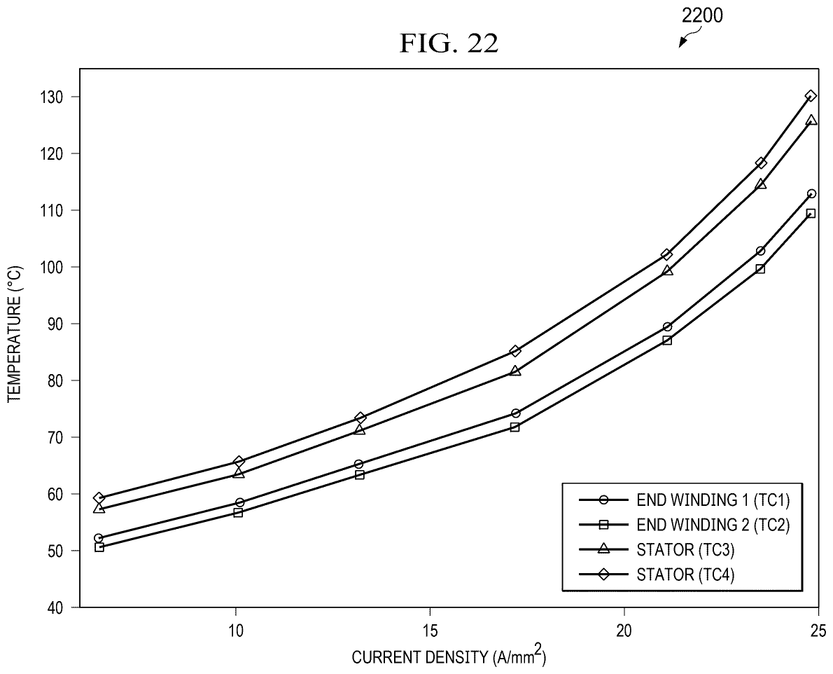

FIG. 22 illustrates the steady-state temperature variation at key monitoring points 2200 within the motor as the current density increases from 6.5 A/mm² to 24.8 A/mm², under active microchannel cooling. As expected, temperature rises with increasing current density due to elevated copper losses. Among all locations, TC4 shows the highest temperature across the entire range, exceeding 130° C. at the maximum current density. TC3 follows closely, highlighting the greater thermal stress in the stator region. In contrast, TC1 and TC2 maintain lower temperature levels, with TC2 consistently exhibiting the lowest values, indicating stronger cooling performance in that zone.

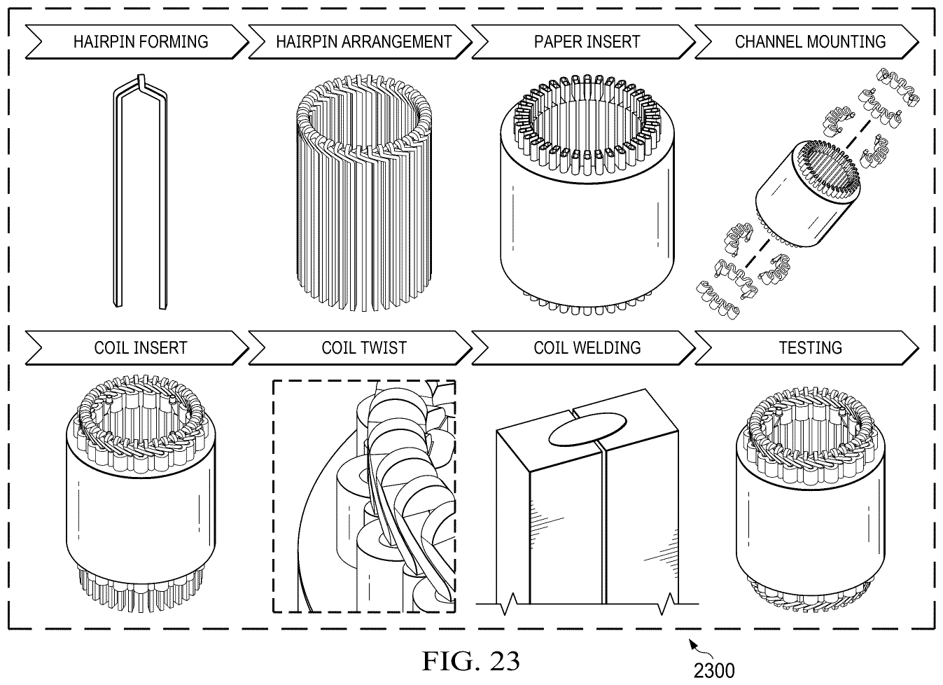

Embodiments, as illustrated in the assembly diagram as shown in FIG. 23, offers a unique advantage by seamlessly integrating microchannel heat exchangers into the hairpin winding structure without compromising the slot area or reducing the copper fill factor. The image clearly demonstrates the motor assembly process with the cooling method, which begins with hairpin forming, where a copper wire is bent into a U-shaped structure. This is followed by hairpin arrangement, where multiple hairpins are pre-positioned in a circular array, ready for insertion. Next, insulating paper (e.g., Nomex) is inserted into the stator slots to provide necessary electrical insulation. In the subsequent step, microchannel heat exchangers (shown in blue) are mounted onto the stator. Once the channels are in place, the pre-arranged hairpins are inserted into the stator slots. After insertion, the protruding ends of the hairpins are twisted to ensure mechanical stability and to prepare them for welding. The twisted ends are then welded together—typically using laser or TIG welding—to create reliable electrical connections. Finally, the fully assembled stator undergoes rigorous testing to validate its electrical and mechanical integrity. The microchannel heat exchangers are strategically placed in the end-winding region, where heat generation is most intense, enabling highly localized and efficient cooling while still supporting high current densities. This innovative design effectively addresses the thermal challenges faced by conventional systems and enables the realization of high-torque, high-power-density electric machines—ideal for next-generation electric vehicle powertrains.

Moreover, FIG. 23 highlights a fully modular, step-by-step assembly process—from hairpin forming through final testing—demonstrating how the cooling solution facilitates streamlined manufacturing, ease of repair, and recyclability. Each stage, including coil insertion, twisting, welding, and testing, is compatible with standard automated production techniques and introduces no additional complexity, despite the incorporation of embedded cooling channels. Since the microchannel cooling system and the windings are developed as distinct modules, they can be independently assembled, serviced, or replaced—greatly simplifying maintenance and end-of-life disassembly. This modularity, paired with the clearly defined and automatable assembly workflow shown in FIG. 23, significantly reduces production time and cost while enhancing sustainability. The system not only delivers superior thermal management but also supports circular (recycling) economy principles, making it a compelling solution for future electric machine designs.

Embodiments present an innovative and highly effective thermal management solution tailored for high-power-density electric machines, particularly suited for electric vehicle propulsion systems. By directly embedding microchannel heat exchangers within the end-winding region of hairpin windings, the method significantly reduces thermal resistance, enabling superior heat extraction from one of the most thermally stressed areas of the motor. Experimental and simulation results confirm that the cooling system maintains winding temperatures well below critical thresholds, even under extreme current densities approaching 25 A/mm².

Unlike conventional cooling methods that often compromise manufacturability, slot fill factor, or long-term reliability, the design preserves high electromagnetic performance while introducing minimal structural complexity. Moreover, the modular nature of the microchannel and winding assembly supports streamlined manufacturing, ease of repair, and end-of-life recyclability—key features for sustainable and scalable deployment in next-generation electric drives. The results demonstrate a significant advancement in motor cooling strategies, pushing the boundaries of power density without sacrificing system robustness. This work lays a strong foundation for future developments in thermal management systems that align with the demanding requirements of high-performance, compact, and reliable electric powertrains.

The descriptions of the various embodiments of the present invention have been presented for purposes of illustration, but are not intended to be exhaustive or limited to the embodiments disclosed or claimed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The term phase is intended to mean a limited range of compositions of a mixture of the elements (in a thermochemical system) throughout which the chemical potential of the mixture varies with composition, and which either changes discontinuously or remains constant outside of that range. The term uniformly is intended to mean unvarying or deviating very little from a given and/or expected value (e.g., within 10% of). The term substantially is intended to mean largely but not necessarily wholly that which is specified. The term approximately is intended to mean at least close to a given value (e.g., within 10% of). The term generally is intended to mean at least approaching a given state. The term coupled is intended to mean connected, although not necessarily directly, and not necessarily mechanically. The term proximate, as used herein, is intended to mean close, near adjacent and/or coincident; and includes spatial situations where specified functions and/or results (if any) can be carried out and/or achieved. The term distal, as used herein, is intended to mean far, away, spaced apart from and/or non-coincident, and includes spatial situation where specified functions and/or results (if any) can be carried out and/or achieved. The term deploying is intended to mean designing, building, shipping, installing and/or operating.

The terms first or one, and the phrases at least a first or at least one, are intended to mean the singular or the plural unless it is clear from the intrinsic text of this document that it is meant otherwise. The terms second or another, and the phrases at least a second or at least another, are intended to mean the singular or the plural unless it is clear from the intrinsic text of this document that it is meant otherwise. Unless expressly stated to the contrary in the intrinsic text of this document, the term or is intended to mean an inclusive or and not an exclusive or. Specifically, a condition A or B is satisfied by any one of the following: A is true (or present) and B is false (or not present), A is false (or not present) and B is true (or present), and both A and B are true (or present). The terms a and/or an are employed for grammatical style and merely for convenience.

The term plurality is intended to mean two or more than two. The term any is intended to mean all applicable members of a set or at least a subset of all applicable members of the set. The phrase any integer derivable therein is intended to mean an integer between the corresponding numbers recited in the specification. The phrase any range derivable therein is intended to mean any range within such corresponding numbers. The term means, when followed by the term “for” is intended to mean hardware, firmware and/or software for achieving a result. The term step, when followed by the term “for” is intended to mean a (sub) method, (sub) process and/or (sub) routine for achieving the recited result. Unless otherwise defined, all technical and scientific terms used herein have the same meaning as commonly understood by one of ordinary skill in the art to which this present disclosure belongs. In case of conflict, the present specification, including definitions, will control.

The described embodiments and examples are illustrative only and not intended to be limiting. Although embodiments of the present disclosure can be implemented separately, embodiments of the present disclosure may be integrated into the system(s) with which they are associated. All the embodiments of the present disclosure disclosed herein can be made and used without undue experimentation in light of the disclosure. Embodiments of the present disclosure are not limited by theoretical statements (if any) recited herein. The individual steps of embodiments of the present disclosure need not be performed in the disclosed manner, or combined in the disclosed sequences, but may be performed in any and all manner and/or combined in any and all sequences. The individual components of embodiments of the present disclosure need not be formed in the disclosed shapes, or combined in the disclosed configurations, but could be provided in any and all shapes, and/or combined in any and all configurations. The individual components need not be fabricated from the disclosed materials, but could be fabricated from any and all suitable materials. Homologous replacements may be substituted for the substances described herein.

Various substitutions, modifications, additions and/or rearrangements of the features of embodiments of the present disclosure may be made without deviating from the scope of the underlying inventive concept. All the disclosed elements and features of each disclosed embodiment can be combined with, or substituted for, the disclosed elements and features of every other disclosed embodiment except where such elements or features are mutually exclusive. For instance, feature(s) of one embodiment may be combined with feature(s) of another embodiment. The scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” or “mechanism for” or “step for”. Sub-generic embodiments of this disclosure are delineated by the appended independent claims and their equivalents. Specific embodiments of this disclosure are differentiated by the appended dependent claims and their equivalents.

What is claimed is:

1. An electric machine, comprising:
a stator having a first end and a second end and defining a plurality of slots;
a plurality of insulators coupled to the stator, located at least partially in the plurality of slots, and extending beyond the first end;
a plurality of windings coupled to the plurality of insulators, located at least partially within and surrounded by the plurality of insulators, and extending beyond the first end; and
a direct thermal contact end-winding microchannel heat exchanger coupled to a section of the plurality of insulators that extends beyond the first end,
wherein the direct thermal contact end-winding microchannel heat exchanger is in direct thermal conduction with a section of the plurality of windings that extends beyond the first end to remove heat from the plurality of windings.

2. The electric machine of claim 1, wherein the direct thermal contact end-winding microchannel heat exchanger defines a shape that serpentines between at least 3 of the plurality of insulators.

3. The electric machine of claim 1, wherein the plurality of insulators comprise a thermal-conductivity epoxy paste.

4. The electric machine of claim 1, wherein the direct thermal contact end-winding microchannel heat exchanger comprises an inlet and an outlet.

5. The electric machine of claim 1, further comprising a coolant located in the direct thermal contact end-winding microchannel heat exchanger.

6. The electric machine of claim 5, wherein the coolant comprises a two phase mixture of liquid and vapor.

7. The electric machine of claim 1, wherein the direct thermal contact end-winding microchannel heat exchanger comprises perturbances to increase internal surface area.

8. The electric machine of claim 1, wherein the direct thermal contact end-winding microchannel heat exchanger is reversibly attachable.

9. A method of making an electric machine, comprising:
providing a stator having a first end and a second end and defining a plurality of slots;
coupling a plurality of insulator sleeves to the stator, wherein the plurality of insulator sleeves are located at least partially in the plurality of slots, and extend beyond both the first end and the second end;
coupling a first modular direct thermal contact end-winding microchannel heat exchanger coupled to a section of the plurality of insulator sleeves that extends beyond the first end;
coupling a second modular direct thermal contact end-winding microchannel heat exchanger coupled to a section of the plurality of insulator sleeves that extends beyond the second end; and
inserting a plurality of windings through the plurality of insulator sleeves wherein the plurality of windings extend beyond both the first end and the second end and extend beyond both the first modular direct thermal contact end-winding microchannel heat exchanger and the second modular direct thermal contact end-winding microchannel heat exchanger.

10. The method of making an electric machine of claim 9, further comprising twisting exposed ends of the plurality of windings that extend beyond both the first modular direct thermal contact end-winding microchannel heat exchanger and the second modular direct thermal contact end-winding microchannel heat exchanger.

11. The method of making an electric machine of claim 10, further comprising welding twisted ends of the plurality of windings that extend beyond both the first modular direct thermal contact end-winding microchannel heat exchanger and the second modular direct thermal contact end-winding microchannel heat exchanger.

12. The method of making an electric machine of claim 9, further comprising
coupling a third modular direct thermal contact end-winding microchannel heat exchanger coupled to a section of the plurality of insulator sleeves that extends beyond the first end; and
coupling a fourth modular direct thermal contact end-winding microchannel heat exchanger coupled to a section of the plurality of insulator sleeves that extends beyond the second end.

13. An electric machine comprising:
a stator having a first end and a second end and defining a plurality of slots;
a plurality of insulators coupled to the stator, located at least partially in the plurality of slots, and extending beyond both the first end and the second end;
a plurality of windings coupled to the plurality of insulators, located at least partially within and surrounded by the plurality of insulators, and extending beyond both the first end and the second end;
a first modular direct thermal contact end-winding microchannel heat exchanger coupled to a section of the plurality of insulators that extends beyond the first end; and
a second modular direct thermal contact end-winding microchannel heat exchanger coupled to a section of the plurality of insulators that extends beyond the second end,
wherein both the first modular direct thermal contact end-winding microchannel heat exchanger and the second modular direct thermal contact end-winding microchannel heat exchanger are in direct thermal conduction with the plurality of windings to remove heat from the plurality of windings, and
wherein both the first modular direct thermal contact end-winding microchannel heat exchanger and the second modular direct thermal contact end-winding microchannel heat exchanger define a substantially equal shape and size.

14. The electric machine of claim 13, further comprising a third modular direct thermal contact end-winding microchannel heat exchanger coupled to another section of the plurality of insulators that extends beyond the first end,
wherein the third modular direct thermal contact end-winding microchannel heat exchanger and both the first modular direct thermal contact end-winding microchannel heat exchanger and the second modular direct thermal contact end-winding microchannel heat exchanger define the substantially equal shape and size.

15. The electric machine of claim 14, further comprising a fourth modular direct thermal contact end-winding microchannel heat exchanger coupled to another section of the plurality of insulators that extends beyond the second end,
wherein the fourth modular direct thermal contact end-winding microchannel heat exchanger, the third modular direct thermal contact end-winding microchannel heat exchanger and both the first modular direct thermal contact end-winding microchannel heat exchanger and the second modular direct thermal contact end-winding microchannel heat exchanger define the substantially equal shape and size.

16. The electric machine of claim 15, wherein the first modular direct thermal contact end-winding microchannel heat exchanger, the second modular direct thermal contact end-winding microchannel heat exchanger, the third modular direct thermal contact end-winding microchannel heat exchanger, and the fourth modular direct thermal contact end-winding microchannel heat exchanger are all separately reversable attachable.

17. The electric machine of claim 13, further comprising a coolant located in the direct thermal contact end-winding microchannel heat exchanger.

18. The electric machine of claim 17, wherein the coolant comprises a two phase mixture of liquid and vapor.

19. The electric machine of claim 13, wherein the substantially equal shape and size serpentines between at least 3 of the plurality of insulators.

20. The electric machine of claim 13, wherein the plurality of insulators comprise a thermal-conductivity epoxy paste.
